(19) United States
(12) Patent Application Publication
(10) Pub. No.: US 2022/0096953 A1
(43) Pub. Date: Mar. 31, 2022

(54) EVAPORATION UNIT AND SYSTEM

(71) Applicant: COPPING REFUSE DISPOSAL SITE JOINT AUTHORITY, Lutana (AU)

(72) Inventors: Christine BELL, Mt Nelson (AU); Michael Edward BARKER, Lutana (AU); Ziven ALEKSA, Claremont (AU)

(21) Appl. No.: 17/424,401

(22) PCT Filed: Jan. 24, 2020
(86) PCT No.: PCT/AU2020/050052

§ 371 Date: Jul. 20, 2021

(30) Foreign Application Priority Data
Jan. 25, 2019 (AU) 2019900235

(51) Int. Cl. B01D 1/00; B01D 1/20; B01D 1/30; C02F 1/04; C02F 1/14

(52) U.S. Cl. CPC B01D 1/0035; B01D 1/007; B01D 1/20; C02F 2103/06; C02F 1/048; C02F 1/14; B01D 1/30

(57) ABSTRACT

An evaporation unit for evaporating liquid from a solution, comprising: a plurality of evaporation elements extending radially outwardly from a common central axis, the evaporation elements being configured for rotation about the central axis; and a liquid discharge system for distributing the liquid onto the evaporation elements to promote evaporation.

### FIELD OF THE INVENTION

The present invention relates to an evaporation unit and system for evaporating water or other liquids from a solution. For example, the unit and system can be used for extracting, by evaporation, water from a solution containing solids, such as wastewater or leachate.

### BACKGROUND

Evaporation of water from a solution containing solids is desirable for many different industrial processes such as dealing with waste. In particular, the extraction of water from wastewater is desirable to concentrate solids for further treatment and/or storage.

In one example, leachate can be a challenging substance to store and treat, particularly due to concerns of leakage and environmental contamination. Accordingly, it is desirable to reduce the amount of leachate available and this is typically done by evaporation, reducing the liquid volume and concentrating the solid content of the solution for further treatment and/or storage.

Previous evaporative systems have been generally complicated and difficult to maintain, and thus expensive, and provide generally limited performance.

There is a need to address the above, and/or at least provide a useful alternative.

### SUMMARY

According to one aspect of the invention there is provided an evaporation unit for evaporating liquid from a solution, comprising:
a plurality of evaporation elements extending radially outwardly from a common central axis, the evaporation elements being configured for rotation about the central axis; and
a liquid discharge system for distributing the liquid onto the evaporation elements to promote evaporation.

Preferably, the evaporation elements are formed of a flexible material extending between rigid support members. The flexible material can be a woven polyester material.

The evaporation elements can be fixed to each other to form a rotating assembly. Preferably, the rotating assembly is mounted on bearings and free to rotate with air movement. The rotating assembly may rotate about a fixed central shaft.

The evaporation unit may further comprise a brake to restrict rotational speed of the rotating assembly. A safety lock to prevent rotation may also be provided.

In some embodiments, the rotating assembly rotates withing an external frame, the external frame having upright members positioned beside the unit and a horizontal member extending therebetween. Where provided, the fixed central shaft is coupled to the horizontal member. A ladder and walkway may be provided on the external frame for access to the units.

The liquid discharge system can include distribution arms extending outwardly from the central axis. The arms are preferably fixed and may also be hollow and form conduits having distribution holes formed therein for spraying the liquid onto the evaporation elements, the holes being formed along the length of the arms. Alternatively a plurality of spray nozzles may be provided in fluid communication with the distribution arms, the spray nozzles being adjustable to vary the angle of liquid spray.

Preferably, the distribution holes are formed in a lower portion of the arm at approximately +/−45 degrees from a vertical plane. The distribution holes formed on a forward side of the arms are staggered with respect to the holes on a rearward side of the arms.

Preferably, the unit is configured for use in evaporating water from leachate.

According to another aspect of the invention, there is provided an evaporation system including a plurality of evaporation units of the above described type.

Preferably, the or each unit is mounted in a leachate pond and leachate from the pond is distributed through the distribution system. Alternatively, the or each unit may be remote from the pond and the leachate pumped to the or each unit.

### BRIEF DESCRIPTION OF THE DRAWINGS

In order that the invention may be more easily understood, preferred embodiments will now be described, by way of example only, with reference to the accompanying drawings, in which:

FIG. 1: is a perspective view of a first embodiment of an evaporation unit;

FIG. 2: is a plan view of the unit;

FIG. 3: is a side view of the unit;

FIG. 4: is a close view of a lower portion of the unit;

FIG. 5: is another close view of a lower portion of the unit;

FIG. 6: is a close view of an upper portion of the unit;

FIG. 7: is another close view of an upper portion of the unit;

FIG. 8: is a section view of a spray arm of the unit;

FIG. 9: is a side view of an evaporation unit of a second embodiment;

FIG. 10: is a plan view of the unit of FIG. 9;

FIG. 11: is a close view of a lower portion of the unit of FIG. 9;

FIG. 12: is a close view of a main shaft assembly of the unit of FIG. 9;

FIG. 13: is a close view of an upper portion of the unit of FIG. 9;

FIG. 14: is a side elevation of an evaporation unit of a second embodiment;

FIG. 15: is a plan view of the unit of FIG. 14;

FIG. 16: is a close view of upper and lower portions of a central shaft of the unit of FIG. 14;

FIG. 17: is a close plan view of a base of the unit of FIG. 14;

FIG. 18: is a close plan view of a brake of the unit of FIG. 14;

FIG. 19: is a perspective view of an evaporation unit of a third embodiment;

FIG. 20: is a plan view of the evaporation unit of FIG. 19;

FIG. 21: is a side sectional view of the evaporation unit of FIG. 19;

FIG. 21a: is a close detail view of Detail M from FIG. 19;

FIG. 22: is a side sectional view of the rotating assembly of the evaporation unit of FIG. 19;

FIG. 22a: is a close detail view of Detail H of FIG. 22;

FIG. 22b: is a close detail view of Detail G of FIG. 22;

FIG. 23: is a close view of section J-J of FIG. 20; and

FIG. 23a: is a close detail view of Detail K of FIG. 23.

### DETAILED DESCRIPTION

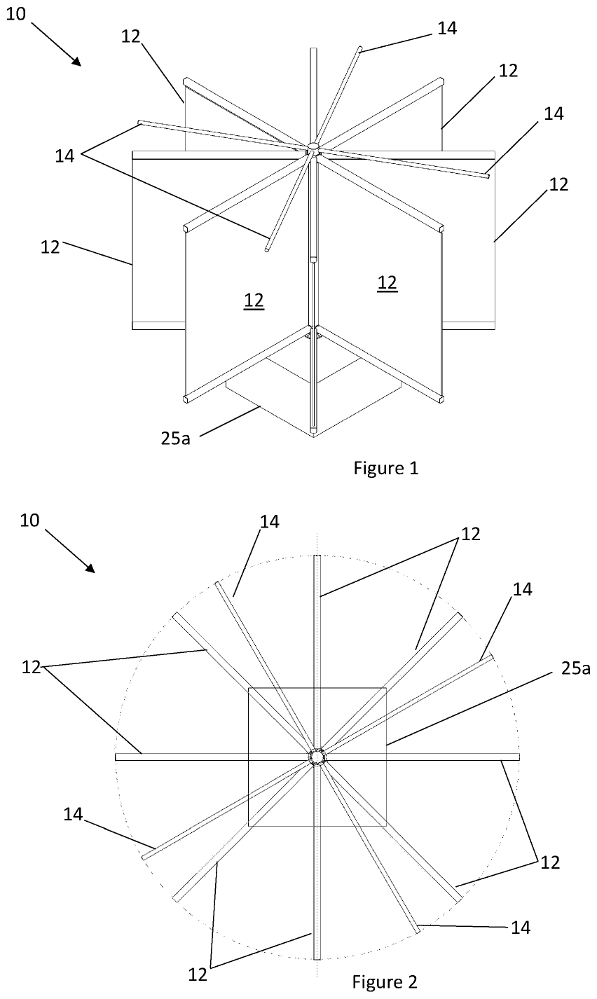

FIG. 1 illustrates an evaporation unit 10 according to a preferred embodiment of the invention. The evaporation unit 10 is configured for evaporating liquid from a solution. In the described embodiment, the unit 10 is configured for removing liquid from leachate. It will be appreciated that unit 10 can also be used with other liquids or types of wastewater.

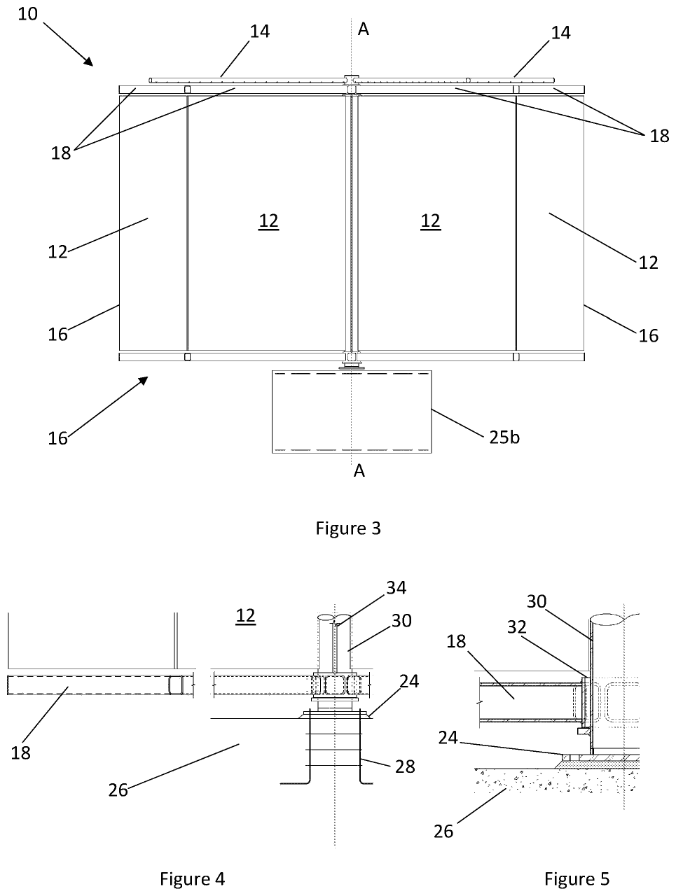

Evaporation unit 10 comprises a plurality of evaporation elements 12 extending radially outwardly from a common central axis A (refer FIG. 3). The evaporation elements 12 are generally planar though they may be non-planar in other configurations and configured for rotation about the central axis A and typically move under the action of wind or the combined action of wind and mechanical drive. In the illustrated embodiment, the evaporation unit has 8 equally spaced evaporation elements 12, though it will be appreciated that unit 10 may have any number of evaporation elements, preferably between 3 and 10 and that the evaporation elements 12 may not be evenly spaced.

Evaporation unit 10 also comprises a liquid discharge system for distributing leachate onto the evaporation elements 12 to promote evaporation. The liquid discharge system includes arms 14 which also extend radially outwardly from the central axis A.

As illustrated in FIG. 3, the evaporation elements 12 are formed of a flexible material 16 extending between rigid support members 18. In the embodiment shown, rigid support members are steel square hollow sections, though may also be formed of round hollow sections or other suitably shaped sections. Support members 18 may extend along all four sides of the material 16 or only along a top and bottom as shown in FIGS. 1 and 2. Preferably, the material 16 is connected to the support members using a quick release method, such as elastic loops and hooks, so that material 16 may be quickly removed for cleaning and/or replacement.

The flexible material 16 is preferably a woven polyester material and has perforations or apertures to allow for air flow therethrough to assist with evaporation of liquid/water from leachate on the material 16 and to capture/adsorb particulate). One particular example of a suitable material is shade cloth such as Montec 370, as manufactured under the Monotec trade mark.

In use, the leachate flows over the material 16 to promote evaporation of the liquid component and leave solids behind, the solids often falling from the material 16 for collection below. By having a flexible material, solids can more easily be removed, in particular by flexing the material, and the evaporation element 12 cleaned.

The evaporation elements 12 together form a rotating assembly 20. Within the rotating assembly 20, the evaporation elements 12 may be fixed together so as to provide a fixed spacing between each element 12, or they may be free to move within a confined space. In other embodiments, the evaporation elements 12 may be able to freely to rotate about the axis A independent of other evaporation elements.

The rotating assembly 20 is mounted on bearings, which will be described further below, and free to rotate with air movement. Rotation may be controlled by mechanical drive or braking. Advantageously the evaporation unit 10 can be used in areas of changing winds and adapt to wind directional changes, something that prior art arrangements cannot, which are set in a compromise position of greatest average wind and cannot adapt to prevailing wind conditions, which can vary over any given year. The Inventors have found that the most determinative factor in evaporation performance is wind availability. The described rotating array allows each evaporating element time in exposure to prevailing wind and natural sunlight, which promotes evaporation and increases overall system efficiency. In comparison, the prior art discloses configurations in which the evaporation elements 12 are not free to move in the wind, or are disposed in an arrangement where wind incidence is compromised on one or more evaporation elements, and the evaporation performance of such units cannot be optimised.

Furthermore, by providing evaporation elements 12 in a radial pattern and having them rotatable about a central axis, the amount of surface area available for evaporation can be maximised over the prior art, thereby increasing system efficiency and performance.

As can be seen in FIGS. 1 and 2, arms 14 extend outwardly from the central axis A. In a preferred embodiment the arms 14 are fixed, though in other embodiments they may rotate with the evaporation elements 12.

The arms 14 are hollow and form conduits having distribution holes 22 formed along their length for distributing the leachate onto the evaporation elements 12. Leachate may be sprayed or dripped directly onto the evaporation elements 12. It may be that the size of the distribution holes varies along the length of the arm 14 so as to provide a more even flow from the different holes along the length of the arm 14.

As illustrated in FIG. 8, the distribution holes 22 are formed in a lower portion of the arm at approximately +/−45 degrees from a vertical plane. By spraying the leachate at a 45 degree angle, the leachate is sprayed onto the elements 12 even if the arms 14 are not evenly spaced between the elements 12. The distribution holes 22 formed on a forward side of the arms are staggered with respect to the holes on a rearward side of the arms 14. The angle of spray and type of spray mechanism may vary between configurations and optimised to suit prevailing conditions.)

As can be seen in FIGS. 4 and 5, the evaporation unit 10 is mounted on an anchor plate 24 secured to a ground surface 26. The unit 10 may be mounted on a base 25a as shown in FIG. 1 or a base 25b as shown in FIG. 3.

Reinforcement 28 may extend below the ground surface 26 to structurally support the evaporation unit 10. The evaporation elements 12, in particular the rigid support members 18 are mounted on a collar for rotation about fixed central shaft 30. Bearing 32 is provided to assist with rotation. Within shaft 30 is a conduit 34, through which leachate is upwardly pumped toward the spray arms 14. Shaft 30 may itself form the conduit or a separate conduit may be provided with the fluid pumped externally of the unit 10

It will be appreciated that wind damage can also be possible under high wind conditions. To avoid wind damage, the unit 10 can also include a brake mounted near a base of the unit 10 to restrict rotational speed of the rotating assembly. In other configurations, the braking mechanism may be mounted away from the central shaft and within the upper portion of the unit.

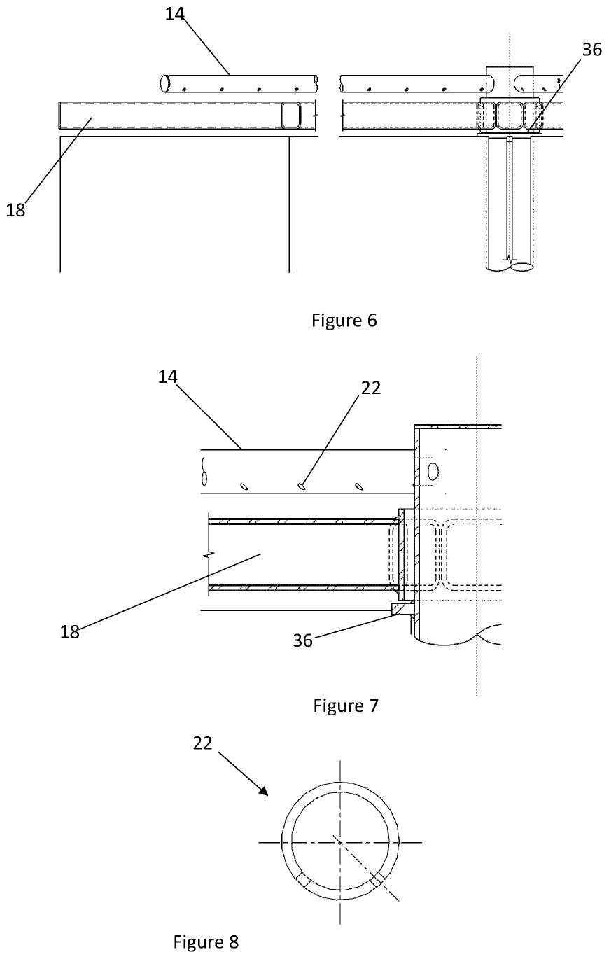

FIGS. 6 and 7 show upper collar 36, upon which the evaporation elements 12 are mounted. It can be seen that spray arms 14 extend above the evaporation elements 12 so that leachate can be directed downwardly onto the evaporation elements 12.

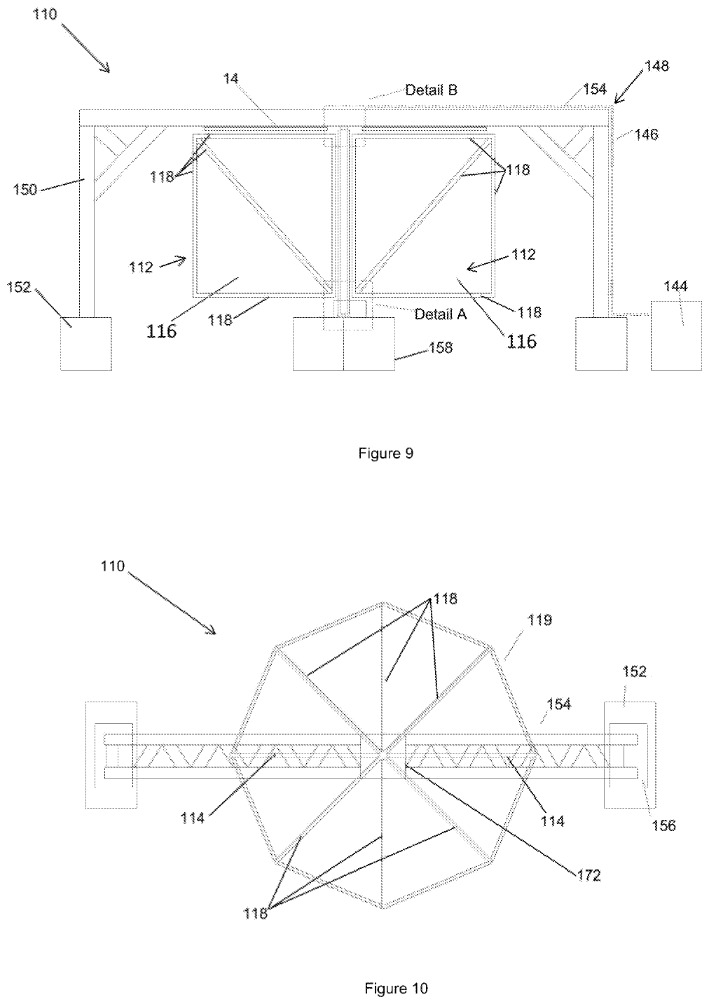

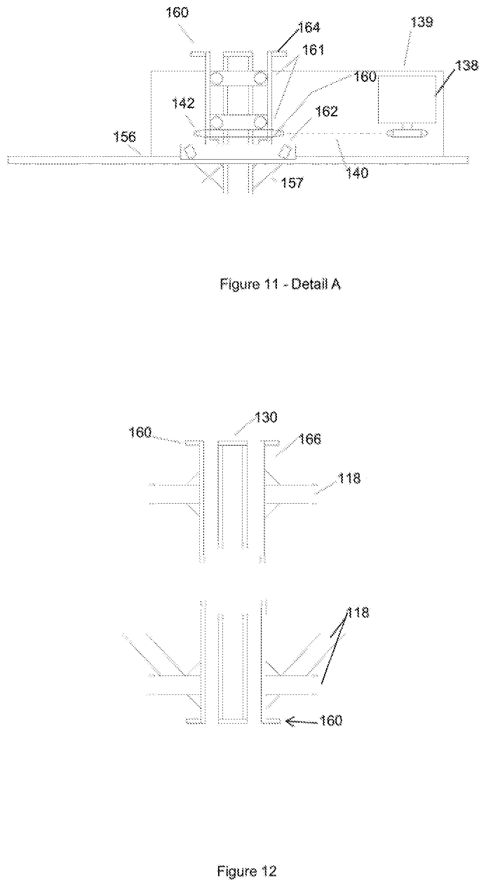

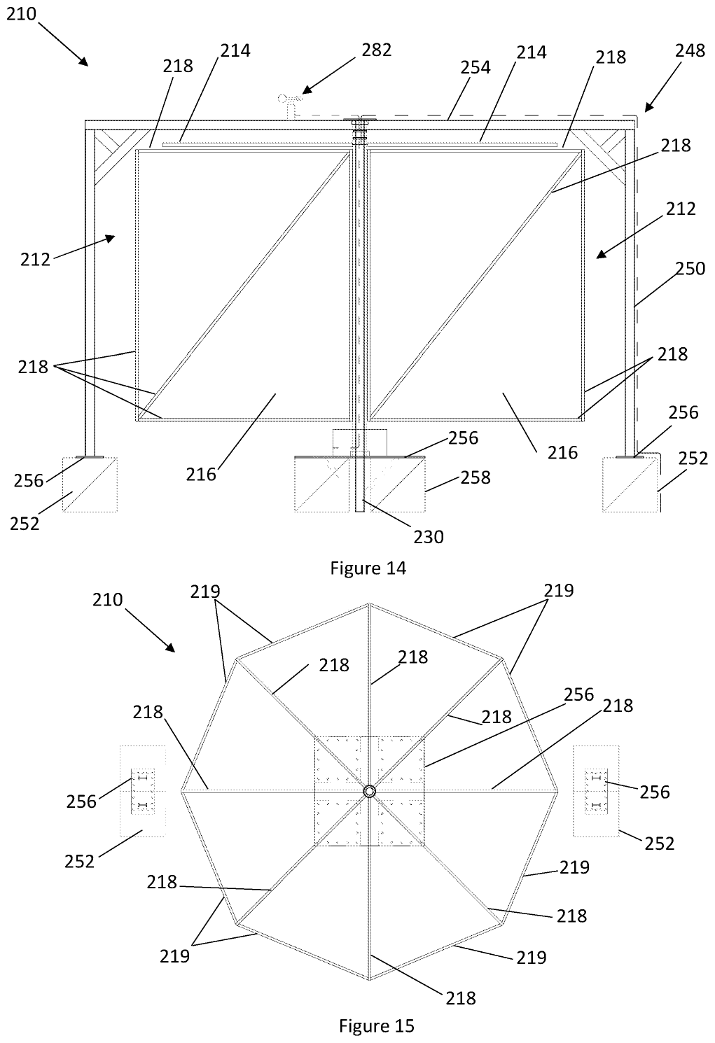

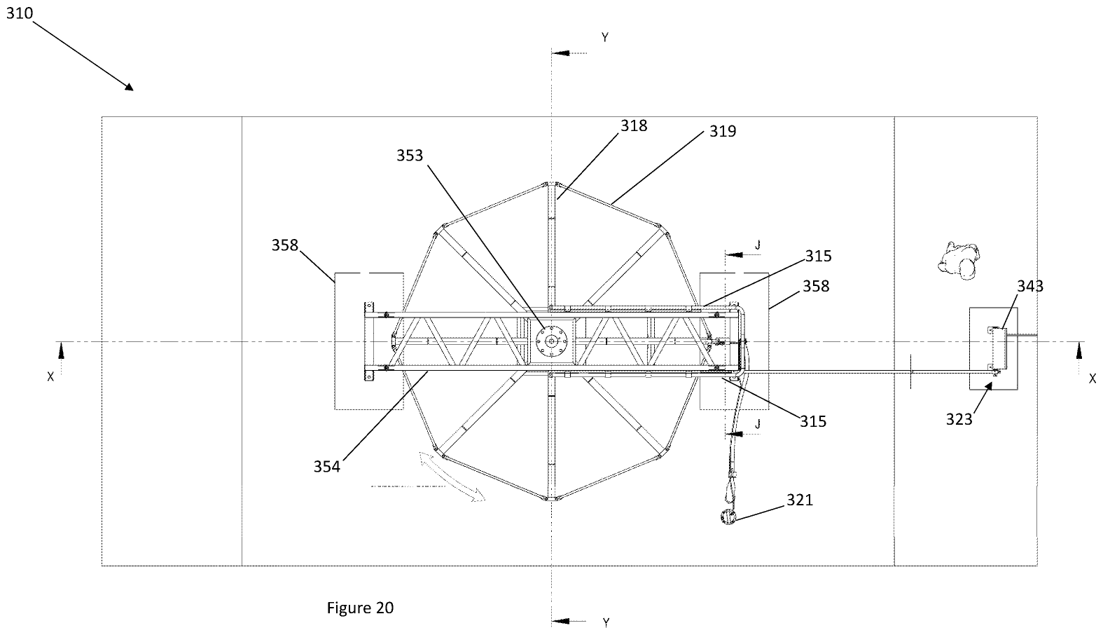

FIGS. 9 to 23a illustrate further embodiments of the invention, with FIGS. 9 to 13 illustrating an evaporation unit 110 according to a second embodiment, FIGS. 14 to 17 illustrating an evaporation unit 210 according to a third embodiment and FIGS. 18 to 23a illustrating an evaporation unit 310 according to a fourth embodiment.

Each of the different evaporation units, 110, 210, 310 are also configured for removing liquid from leachate and share numerous common features with unit 10 and like features have been given like reference numerals that have been incremented by 100.

In particular, each evaporation unit 110, 210, 310 comprises a plurality of evaporation elements 112, 212, 312 extending radially outwardly from a common central axis. The evaporation elements 112, 212, 312 are configured for rotation about the central axis A and typically move under the action of wind and/or mechanical drive. In the illustrated embodiments, each evaporation unit has 8 equally spaced evaporation elements 112, 212, 312, though it will be appreciated that units may have any number of evaporation elements, preferably between 3 and 10 and that the evaporation elements may not be evenly spaced.

Each evaporation unit 110, 210 310 also comprises a liquid discharge system for distributing leachate onto the evaporation elements 112, 212, 312 to promote evaporation. The liquid discharge system includes arms 114, 214, 315 which also extend radially outwardly from the central axis A.

The evaporation elements 112, 212, 312 are also formed of a flexible material 116, 216, 316 extending between rigid support members 118, 218, 318. In the embodiment shown, rigid support members 118, 218, 318 are steel square hollow sections, though may also be formed of round hollow sections or other suitably shaped sections and materials. Support members 118, 218, 318 extend along all four sides of the material 116, 216, 316 with a diagonal cross brace passing over a central portion thereof. The material 116, 216, 316 may be connected to the support members using a quick release method, such as elastic loops and hooks, so that the material may be quickly removed for cleaning and/or replacement. It will be appreciated that other methods of retaining the material on the support members are also possible.

The flexible material 116, 216, 316 is preferably a woven polyester material and has perforations or apertures to allow for air flow therethrough to assist with evaporation of liquid from the leachate on the material 116, 216, 316 and to capture/absorb particulate matter from the leachate. One particular example of a suitable material is shade cloth such as Montec 370, as manufactured under the Monotec trade mark.

In use, the leachate flows over the material 116, 216, 316 to promote evaporation of the liquid component and leave solids behind. By having a flexible material, solids can more easily be removed, in particular by flexing the material, and the evaporation element 112, 212, 312 cleaned.

The evaporation elements 112, 212, 312 are fixed to each other to form a rotating assembly 120, 220, 320. In this regard, a rigid connection 119, 219, 319 extends between each element 112, 212, 312 to secure them together.

In other embodiments, within the rotating assembly 120, 220, 320 the evaporation elements 112, 212, 312 may be free to move within a confined space. In other embodiments, the evaporation elements may be able to freely to rotate about the central axis independent of other evaporation elements. The rotating assembly 120, 220, 320 may be free to rotate with air movement or may be mechanically driven.

Arms 114, 214 of the liquid distribution system extend outwardly from the central axis and are preferably fixed, though in other embodiments they may rotate with the evaporation elements 112, 212. Additional arms may also be provided.

The arms 114, 214 are hollow and form conduits having distribution holes formed along their length for distributing the leachate onto the evaporation elements 112, 212. Leachate may be sprayed or dripped directly onto the evaporation elements 112, 212. It may be that the size of the distribution holes varies along the length of the arm so as to provide a more even flow from the different holes along the length of the arm 114, 214.

The distribution holes may be formed in a lower portion of the arm at approximately +/−45 degrees from a vertical plane. The distribution holes formed on a forward side of the arms are staggered with respect to the holes on a rearward side of the arms 114, 214.

In the embodiment of FIGS. 9 to 13, the rotating assembly 120 is mounted on bearings, which will be described further below, and free to rotate with air movement. Advantageously the evaporation unit 110 can be used in areas of changing winds and adapt to wind directional changes, something that prior art arrangements cannot. The Inventors have found that the most determinative factor in evaporation performance is wind availability. By having an arrangement in which the evaporation elements 112 are not free to move in the wind, or are disposed in an arrangement where wind incidence is compromised, evaporation performance of a unit cannot be optimised. By providing evaporation elements 112 in a radial pattern and having them rotatable about a central axis, the amount of surface area available for evaporation can be maximised, thereby increasing system efficiency and performance.

As can be seen in FIG. 10, two arms 114 are secured underneath horizontal member 154 for distributing leachate.

It will be appreciated that wind damage can also be possible under high wind conditions. To avoid wind damage, the unit 110 can also include a brake unit 139 to restrict rotational speed of the rotating assembly. Brake unit 139 is filled with hydraulic oil and includes braking motor and associated control valves 138. Motor 138 is connected to shaft 130 via drive chain 140 and cog 142 coupled to the shaft 130. Brake 138 and the associated reservoir tank 144 and heat exchanger are preferably mounted within bunding of the system. Brake 138 and reservoir tank 144 are connected via line 146.

As illustrated in FIGS. 9 and 10, evaporation unit 110 is mounted to an external frame 148. Frame 148 includes uprights 150 which are supported on concrete blocks 152. Between uprights 150 is a horizontal member 154 and the fixed central shaft 130 is coupled to the horizontal member 154.

Evaporation unit 110 is mounted to base plate 156, supported by gusset 157, and which is secured to concrete footing 158.

To provide ease of assembly, the fixed shaft 130 is split into sections and lower rotation section 164 provided. Assembly flanges 160, which are rotatable about the fixed central shaft due to ball bearings 161 and thrust bearing 162, allow for fitment of a rotating assembly thereto.

The central section of shaft 130 can be seen in FIG. 12. Assembly flanges 160 allow for fitment to the lower rotation section 164 and lower fixed section 130a. Outer shaft 166 is provided to support the support members 118, which extend therefrom.

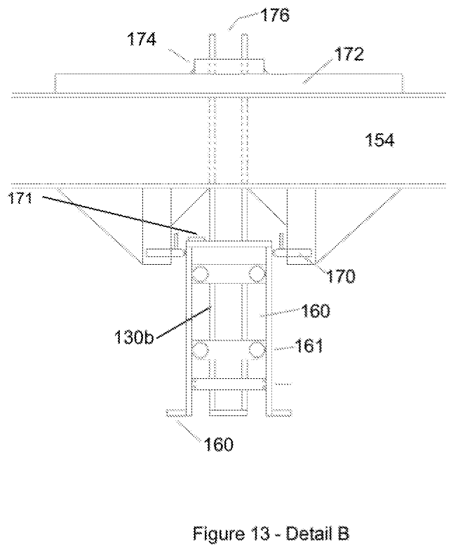

At an upper portion of the shaft 130, as illustrated in FIG. 13, mounting flanges are again provided for mounting the central portion of the shaft to the upper portion. To ensure smooth rotation between the fixed shaft 130 and outer shaft 166, ball bearings 161 are provided. Between fixed shaft 130 and outer shaft 166, a chamber 168 is formed, this chamber being filled with hydraulic oil.

Top mounting plate 172 may be secured to the horizontal member 154 with bolts 174 extending through the top mounting plate 172 downwardly into the fixed shaft 130. Hydraulic hoses 176 may pass through the centre of the fixed shaft 130. Oil seal 180 is provided for sealing purposes.

To lock the unit 110 against rotation, emergency locking pins 170 are provided. A striker tab 171 is also provided which will activate if the unit spins fast, thereby locking the pins 170 in position to stop the unit from spinning and reducing the likelihood of damage. Striker tab 171 acts as a failsafe in the event of failure with the hydraulic for associated hydraulic hoses or a power failure during times of high winds.

As illustrated in FIG. 9, spray arms 114 again extend outwardly from the central axis. The spray arms 114 are fixed to the support structure 148, though may be free to rotate with the evaporation elements in other embodiments. Although only two spray arms 114 are shown, it will be appreciated that additional spray arms may be provided.

FIGS. 14 to 17 illustrate an evaporation unit 210 according to another embodiment of the invention.

Further to the description above, in this embodiment, the spray arms 214 are fixed to the support structure 248, though may be free to rotate with the evaporation elements in other embodiments. In some embodiments only two spray arms 214 are provided, though it will be appreciated that additional spray arms may be provided, such as three or four for example.

The arms 214 form conduits having distribution holes formed therein for spraying the leachate, the holes being formed along the length of the arms. Again, the distribution holes are formed in a lower portion of the arm at approximately +/−45 degrees from a vertical plane, and the distribution holes formed on a forward side of the arms are staggered with respect to the holes on a rearward side of the arms.

The rotating assembly 220 is mounted on bearings 261/262, which will be described further below, and free to rotate with air movement. Advantageously the evaporation unit 210 can be used in areas of changing winds and adapt to wind directional changes, something that prior art arrangements cannot. The Inventors have found that the most determinative factor in evaporation performance is wind availability. By having an arrangement in which the evaporation elements 212 are not free to move in the wind, or are disposed in an arrangement where wind incidence is compromised, evaporation performance of a unit cannot be optimised. By providing evaporation elements 212 in a radial pattern and having them rotatable about a central axis, the amount of surface area available for evaporation can be maximised, thereby increasing system efficiency and performance.

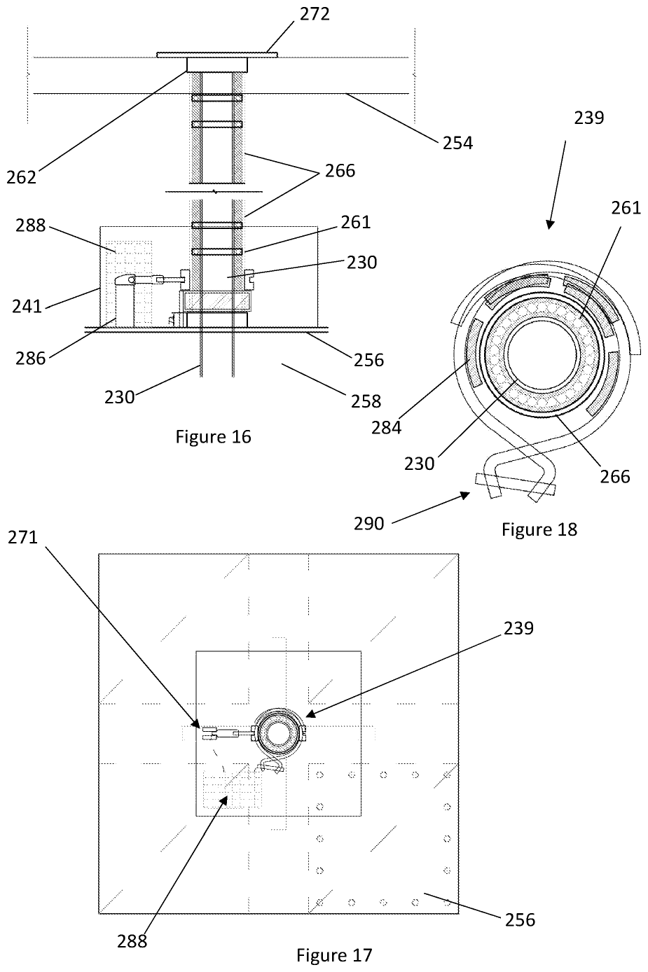

It will again be appreciated that wind damage can be possible under high wind conditions. To avoid wind damage, the unit 210 can also include a brake unit 239, as shown in FIGS. 16 to 18, to restrict rotational speed of the rotating assembly. Brake unit 239 is mounted within enclosure 241.

In this embodiment, brake unit 239 is a friction brake with shoes 284 that act against outer shaft 266 to slow rotation. Brake unit 239 is operable via a hydraulic ram 286 that urges the shoes 284 against the outer shaft 266. A hydraulic control box 288 is provided to control operation of the hydraulic ram 286 and a bias spring 290 is provided to maintain the shoes 284 spaced from the shaft 266 when not in use.

To lock the unit 210 against rotation, emergency locking pins 270 are provided to lock the brake 239 in an “on” position. A wind sensor 282 is provided to measure wind speed at the unit 210. Preferably the wind sensor 282 is mounted on the horizontal member 254, though it may also be mounted remotely from the unit 210.

In use, the unit 210 will operate with the rotating assembly 220 free to rotate about shaft 230. As wind speed increased, the rotation speed of the assembly 220 can increase and at a predetermined speed the brake will activate to slow the assembly 220. In situations where the speed of the assembly 220 is variable, it may be that the brake is applied temporarily to slow the assembly 220 to an acceptable level. If speed of the assembly 220 rises to a predetermined level, either instantaneously or using a time average, the locking pins 270 may be activated to lock the assembly 220 against rotation until the wind speed reduces to a safe level. The wind speed sensor 282 is provided to determine if the wind speed at the site has decreased after the emergency locking pins 270 are activated. Once this happens, the hydraulic control box 288 allows release of the pins and the brake 239 so that the assembly 220 is again free to rotate.

Evaporation unit 210 is also mounted to an external frame 248. Frame 248 includes uprights 250 which are supported on concrete blocks 252. Between uprights 250 is a horizontal member 254 and the fixed central shaft 230 is coupled to the horizontal member 254.

Evaporation unit 210 is mounted to base plate 256, which is secured to concrete footing 258, with shaft 230 being supported by gussets secured within a concrete footing.

Shaft 230 is a fixed continuous shaft extending from the concrete footing 258 to the horizontal member 254. Outer shaft 266 rotates around inner shaft 230 and is provided to support the rotating assembly 220, with the support members 218 extending therefrom.

To ensure smooth rotation between the fixed shaft 230 and outer shaft 266, ball bearings 261 are provided, with two at a lower portion of the shaft and two at an upper portion of the shaft. A thrust bearing 262 is provided at lower and upper locations on the shaft 230.

Between fixed shaft 230 and outer shaft 266, a chamber 268 is formed, this chamber being filled with hydraulic oil. Preferably ISO46 hydraulic oil is used.

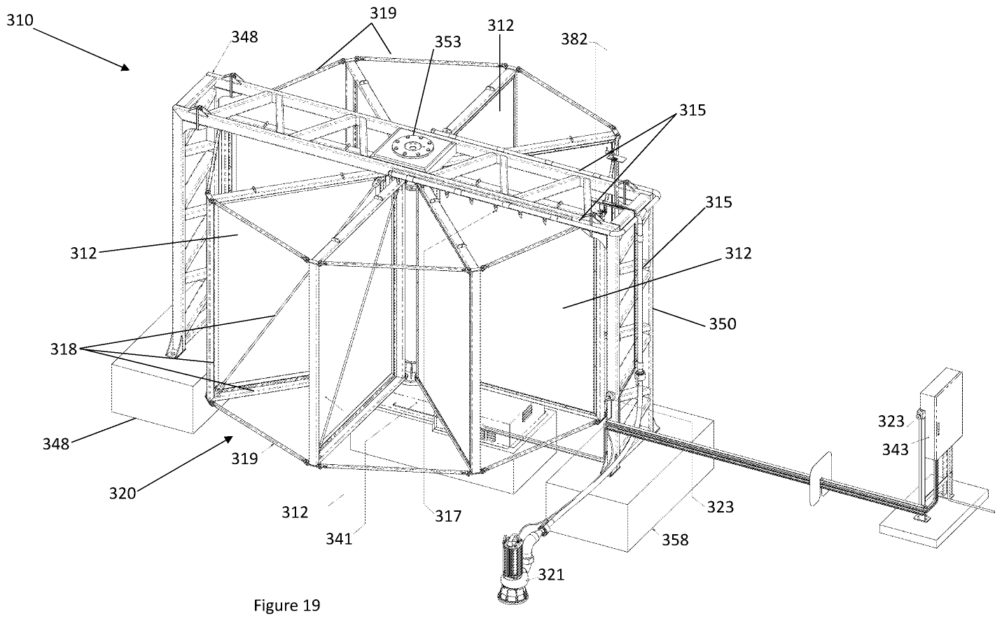

FIGS. 19 to 23 illustrate an evaporation unit 310 according to another embodiment of the invention.

Further to the description above, in this embodiment radial spray arms are omitted and instead conduits 315 are provided on either side of the horizontal member 354, the conduits 315 having a plurality of spray nozzles 317 fitted thereto for distributing leachate onto the evaporation elements 312. The conduits 315 deliver leachate via plumbing affixed to and along supporting frame 350. The spray nozzles 317 are angled forward/backward and to either side as required to achieve optimal spraying. Pump 321 is provided to pump the leachate through the conduits 315 to the nozzles. Pump 321 may be mounted remote from the unit 310.

The rotating assembly 320 is again free to rotate with air movement and is mounted on shaft 330, via support assemblies 392, 394, which will be described further below. Advantageously the evaporation unit 310 can be used in areas of changing winds and adapt to wind directional changes, something that prior art arrangements cannot. The Inventors have found that the most determinative factor in evaporation performance is wind and sun availability. By having an arrangement in which the evaporation elements 312 are not free to move in the wind, or are disposed in an arrangement where wind incidence is compromised, evaporation performance of a unit cannot be optimised. By providing evaporation elements 312 in a radial pattern and having them rotatable about a central axis, the amount of surface area available for evaporation can be maximised, thereby increasing system efficiency and performance.

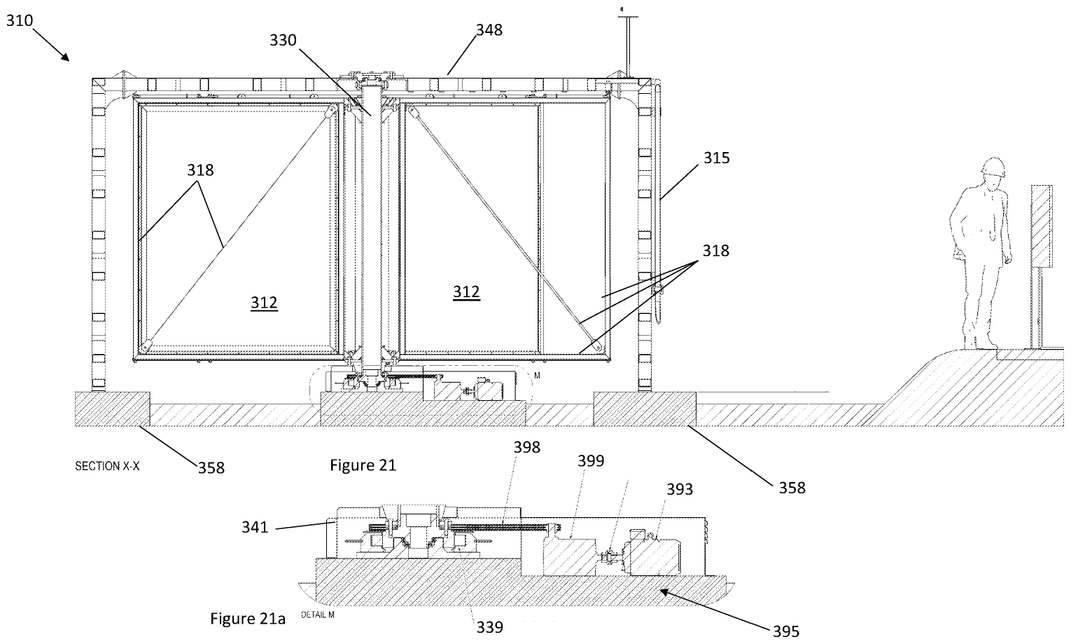

It will again be appreciated that wind damage can be possible under high wind conditions. To avoid wind damage, the unit 310 can also include a brake unit 339, as shown in FIG. 21a, to restrict rotational speed of the rotating assembly. Brake unit 339 is mounted within enclosure 341. Emergency stop buttons 323 may be provided so that a user can directly cease operation of the unit 310. An additional safety mechanism may be provided to enable physical prevention of operation, such as a chain or other manually attachable item.

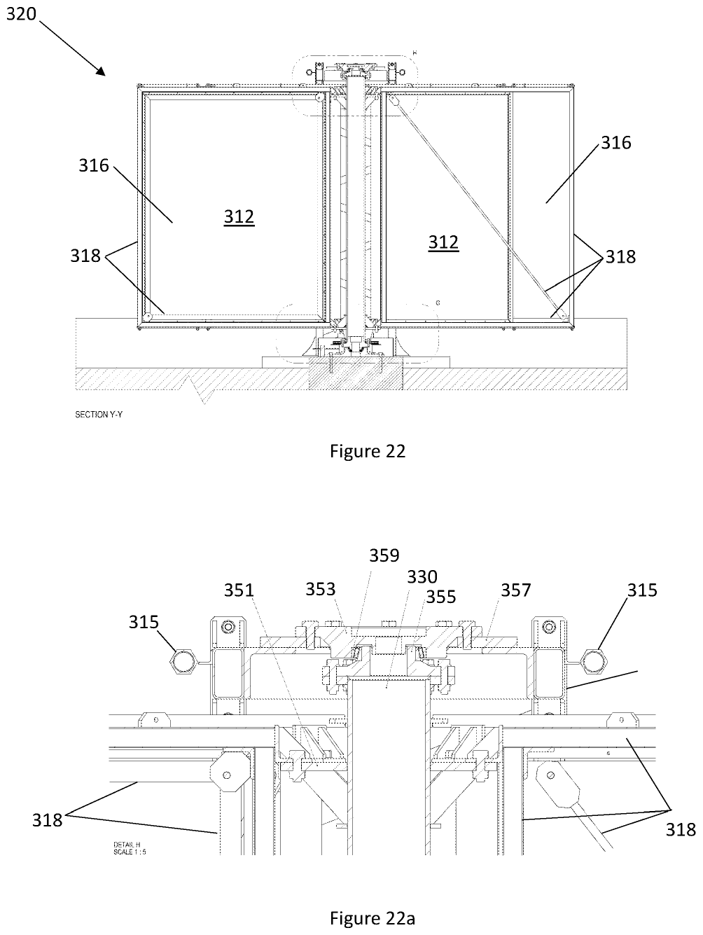

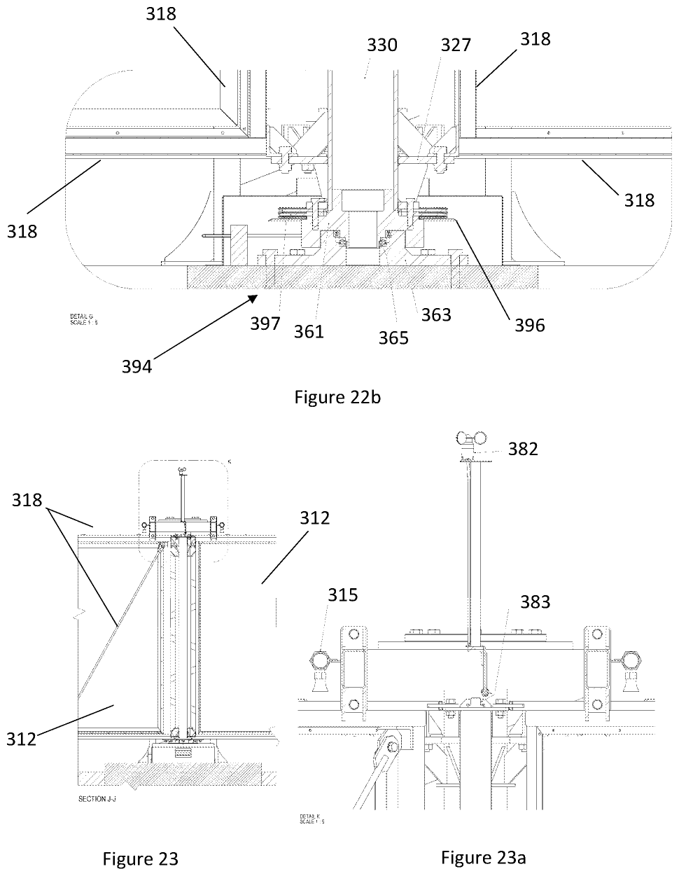

As illustrated in FIG. 22b, brake rotor 396 is provided to retard motion of the rotating assembly 320.

A drive unit 395 is provided to drive the rotating assembly 320 in times of low wind. Drive unit operates via sprockets 397 coupled to shaft 330 and which are driven via chain 398 by motor 393 via high reduction gearbox 399. In other embodiments, the rotating assembly 320 may be driven by a system mounted to the top or towards the outer circumference of the unit and may utilise drive machanisms such as tracks and wheels, pulleys, or a rack and pinion.

Again, an emergency locking system is provided to lock the rotating assembly against rotation. The emergency locking system can include a safety lockout to isolate the power supply to the drive unit 395.

An anemometer 382 is provided to measure wind speed of the unit 310. Preferably the anemometer 382 is mounted on the horizontal member 354, though it may also be mounted remotely from the unit 310. An electromagnetic sensor and magnet tachometer 383 are provided to determine rotational speed of the unit 310. A control cabinet 343 is provided to house electrical connections and monitoring equipment. Provisional for remote monitoring and access may be installed in the cabinet 343.

In use, the unit 310 may operate with the rotating assembly 320 free to rotate about shaft 330 or it may be driven. As wind speed increases, the rotation speed of the assembly 320 can increase and at a predetermined speed the brake will activate to slow the assembly 320. In situations where the speed of the assembly 320 is variable, it may be that the brake is applied temporarily to slow the assembly 320 to an acceptable level. If wind speed rises to a predetermined level, either instantaneously or using a time average, the emergency locking system may be activated to lock the assembly 320 against rotation until the wind speed reduces to a safe level. The anemometer 382 is provided to determine if the wind speed at the site has decreased after the emergency locking system has been activated. The anemometer 382 will provide data to a control system (not shown) which will then be used to optimise rotational speed to prevent damage to the system during high wind conditions, as well as provide ongoing environmental data for general system optimisation. The braking system will be used to prevent over-speeding, dampen cyclic rotational loading caused by phenomena such as wind vortex shedding, and bringing the rotating components to a controlled stop.

With reference to FIG. 22, the rotating assembly 320 comprises at its core a central shaft 330. FIG. 22a provides detail of an upper connection of the shaft and FIG. 22b provides detail of a lower connection of the shaft.

With reference to FIG. 22a, it can be seen that the evaporation elements are secured to the shaft 330 via mounting hub 351. At an upper of the shaft 330 there is a spindle axle 355 that is rotatably supported in mounting hub 353 via tapered roller bearings 359. Mounting plate 357 is provided between the hub 353 and the external frame 348.

As a lower end of the shaft 330, mounting hub 327 is provided to secure the evaporation elements 312 to the shaft 330. A lower spindle axle 361 and brake rotor 361 is provided and is rotatably mounted in lower axle hub 363 via thrust and radial roller bearings 365. Driven sprockets 397 are fixed to the lower spindle axle 361.

As can be seen in FIG. 23a, an electromagnetic sensor and magnet tachometer 383 is provided so that the rotational speed of the rotating assembly 320 can be determined. An anemometer is also provided to measure wind data.

Evaporation unit 310 is also mounted to an external frame 348. Frame 348 includes uprights 350 which are supported on concrete blocks 352. Between uprights 350 is a horizontal member 354 and the fixed central shaft 330 is coupled to the horizontal member 354.

Evaporation unit 310 is mounted to base plate 356, which is secured to concrete footing 358, with shaft 330 being supported by gussets secured within a concrete footing.

Evaporation unit 10, 110 or 210, 310 may be part of an evaporation system including a plurality of evaporation units, each of which may be the same or different. The or each unit can be mounted in a leachate pond so that dried solids are collected in the pond, and leachate from the pond is distributed through the distribution system. Alternatively, the units may be mounted remote from the pond and the leachate pumped thereto.

In the foregoing description, different features are present in different embodiments and although they may not be explicitly described, it will be appreciated that some of those features will be interchangeable between the different units 10, 110, 210, 310.

Those skilled in the art will understand that although the described embodiments are for use with evaporating leachate, they may be adapted for use with evaporating liquids in other processes, such as in wine production for example.

Those skilled in the art will appreciated that modifications may be made to the described embodiments will still fall within the scope of the present disclosure. For example, the number of evaporation elements, their material and construction may vary. The distribution system may be otherwise constructed, and the external frame may also take a different form, including for example a ladder and walkway to provide access to the unit, particularly upper portions thereof.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An evaporation unit for evaporating liquid from a solution, comprising:
a plurality of evaporation elements extending radially outwardly from a common central axis, the evaporation elements being configured for rotation about the central axis; and
a liquid discharge system for distributing the liquid onto the evaporation elements to promote evaporation.

2. An evaporation unit according to claim 1, wherein the evaporation elements are generally planar and formed of a flexible material extending between rigid support members.

3. An evaporation unit according to claim 2, wherein the flexible material is a woven polyester material.

4. An evaporation unit according to claim 1, wherein the evaporation elements are fixed to each other to form a rotating assembly.

5. An evaporation unit according to claim 4, wherein the rotating assembly is mounted on bearings and free to rotate with air movement.

6. An evaporation unit according to claim 4, further comprising a brake to restrict rotational speed of the rotating assembly.

7. An evaporation unit according to claim 4, wherein the rotating assembly rotates about a fixed central shaft.

8. An evaporation unit according to claim 7, wherein the fixed central shaft is secured to an external frame, the external frame having upright members positioned beside the unit and a horizontal member extending therebetween, the fixed central shaft being coupled to the horizontal member.

9. An evaporation unit according to claim 1, wherein the liquid discharge system includes distribution arms extending outwardly from the central axis.

10. An evaporation unit according to claim 9, wherein the arms are fixed.

11. An evaporation unit according to claim 9, wherein the arms are hollow and form conduits having distribution holes formed therein for spraying the liquid onto the evaporation elements, the holes being formed along the length of the arms.

12. An evaporation unit according to claim 11, wherein the distribution holes are formed in a lower portion of the arm at approximately +/−45 degrees from a vertical plane.

13. An evaporation unit according to claim 12, wherein the distribution holes formed on a forward side of the arms are staggered with respect to the holes on a rearward side of the arms.

14. An evaporation unit according to claim 1, configured for use in evaporating water from leachate.

15. An evaporation system including a plurality of evaporation units according to claim 1.

16. An evaporation system according to claim 15, wherein the or each unit is mounted in a leachate pond and leachate from the pond is distributed through the distribution system.
